(19) United States
(12) Patent Application Publication
(10) Pub. No.: US 2002/0013784 A1
(43) Pub. Date: Jan. 31, 2002

(54) Audio data transmission system and method of operation thereof

(76) Inventor: Raymond H. Swanson, Washington, DC (US)

Correspondence Address: PEPPER HAMILTON, 600 FOURTEENTH STREET NW, WASHINGTON, DC, 20005, US

(21) Appl. No.: 09/729,108

(22) Filed: Dec. 5, 2000

Related U.S. Application Data
(60) Provisional application No. 60/221,893, filed on Jul. 31, 2000.

(51) Int. Cl. G06F 17/30

(52) U.S. Cl. 707/104.1; 707/10; 700/94

(57) ABSTRACT

A system and method for transmitting audio data files which includes a service provider server for storing a number of audio data files and categorization data for the audio data files. A data transmitting device is provided which includes circuitry for accessing the service provider server to obtain an audio data file and said categorization data, and circuitry for wirelessly transmitting said audio data and categorization data. A data receiving and playback device is also provided which includes circuitry for wirelessly receiving the audio data file and the categorization data from the data transmitting device, and circuitry for outputting the categorization data and for decoding the audio data file to be broadcast in full stereo and audio fidelity.

### PRIORITY

The following application claims priority to U.S. Provisional Patent Application Serial No. 60/221,893 filed Jul. 31, 2000.

### FIELD OF THE INVENTION

The present invention relates generally to data transmission. More particularly, the invention relates to a system and method for transmitting and playing back audio data.

### BACKGROUND OF THE INVENTION

The downloading, copying and exchange of digital audio files, particularly music files, over the Internet has received considerable attention in the recent past. A testament to the popularity of obtaining music files over the Internet is the large number of users of the dot corn companies, such as MP3.com, emusic.com, and Napster, which permit the downloading and sharing of MP3 and WMA files over the Internet.

The success of these services is directly attributable to advances in audio digital data coding/decoding (CODEC) techniques used to store files to be transferred over the Internet. These CODECs permit audio files to be stored in smaller files for transfer over the Internet so that they can be quickly downloaded, even over lower data rate modems, and buffered and stored on the personal computers (PCs) of users. Furthermore, these compression techniques permit the audio files to be reproduced and played back by the user relatively undistorted.

Because of the difficulty in tracking and prohibiting exchanges of music using the foregoing services, and because of the quality of the reproduced audio files, content providers have raised concerns about their ability to obtain payment from users exchanging files. Content providers are concerned that the incentive to create such content is being eroded by such services.

Furthermore, notwithstanding the foregoing improvements in CODEC technology, available hard drive memory space still prohibits most users from maintaining large libraries of digital audio files on their PCs. While recordable CDs and other data storage devices have been used to alleviate this problem, the larger a users library of files becomes the more CDs are required and thus, the more difficult it becomes to find and play individual files. Similarly, while portable devices exist for playing CDs and other data storage devices, it is cumbersome to carry around more than a few such data storage devices thereby limiting the choices of those having extensive libraries.

The foregoing limitations result, in large part, from the necessity of storing the digital audio files locally by the user for playback. A method and apparatus which overcomes these limitations and permits users to quickly and easily access and store large numbers of digital audio files is still needed.

### SUMMARY OF THE INVENTION

The foregoing needs have been satisfied to a great extent by the present invention which provides in one aspect a system for transmitting audio data files which includes a service provider server for storing a number of audio data files and categorization data for the audio data files. A data transmitting device is provided which includes circuitry for accessing the service provider server to obtain an audio data file and said categorization data, and circuitry for wirelessly transmitting said audio data and categorization data. A data receiving and playback device is also provided which includes circuitry for wirelessly receiving the audio data file and the categorization data from the data transmitting device, and circuitry for outputting the categorization data and for decoding the audio data file to be broadcast in full stereo and audio fidelity.

In another aspect of the invention, a method is provided for transmitting and playing audio data files by accessing categorization data for a plurality of audio data files from a service provider server. The categorization data is output through an output device and an a audio data file is selected to be played on a speaker using the categorization data. The audio data file is transferred from the service provider server to a data transmitting device and wirelessly transmitted to a data receiving and playback device. The audio data file is then broadcast through a speaker.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram representation of a audio data transmission system in accordance with a preferred embodiment of the present invention.

FIG. 2 is a block diagram representation of the circuitry provided in a headset of a preferred embodiment of the present invention.

FIG. 3 is a flowchart representing signals exchanged between the provider software agent, the gateway or network base station, and a stereo headset or playback station during a post initialization operation of the system of FIG. 1.

FIG. 4 is a flowchart representing signals exchanged between the provider software agent, the gateway or network base station, and a stereo headset or playback station during a serial number check procedure performed by the system of FIG. 1.

FIG. 5 is a flowchart representing signals exchanged between the provider software agent, the gateway or network base station, and a stereo headset or playback station when a request is made by a subscriber to listen to an audio channel in the system of FIG. 1.

FIG. 6 is a flowchart representing signals exchanged between the provider software agent, the gateway or network base station, and a stereo headset or playback station during a request to display a library listing in the system of FIG. 1.

FIG. 7 is a flowchart representing signals exchanged between the provider software agent, the gateway or network base station, and a stereo headset or playback station during a request to listen to a playlist on a web site other than the providers in the system of FIG. 1.

FIG. 8 is a flowchart representing signals exchanged between the provider software agent, the gateway or network base station, and a stereo headset or playback station during a request to listen to a playlist on a the providers web site in the system of FIG. 1

FIG. 9 is a flowchart representing signals exchanged between the provider software agent, the gateway or network base station, and a stereo headset or playback station during a request to listen to a playlist on a the user's PC in the system of FIG. 1

FIG. 10A and 10B are flowcharts representing signals exchanged between the provider software agent, the gateway or network base station, and a stereo headset or playback when a user is building a playlist in the system of FIG. 1

### DETAILED DESCRIPTION OF PREFERRED EMBODIMENTS OF THE INVENTION

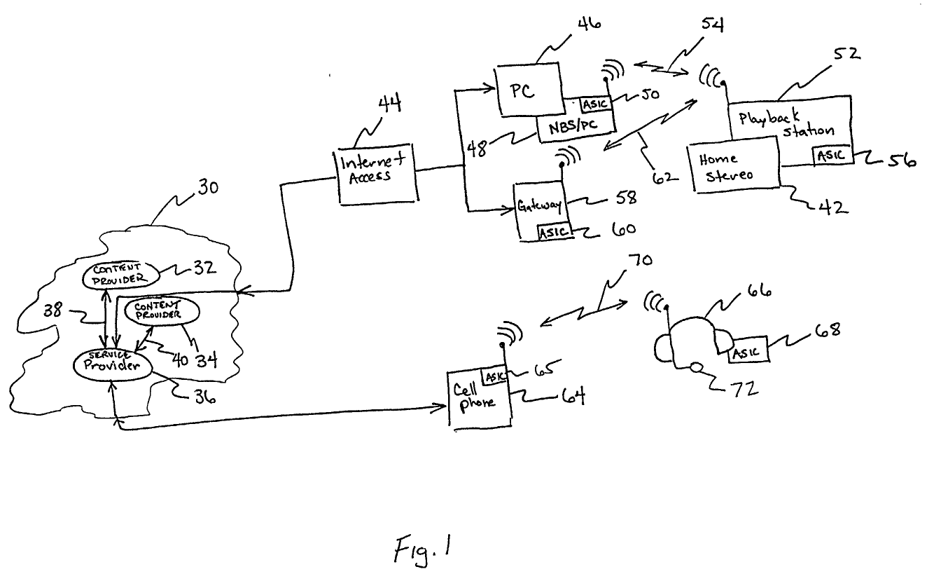

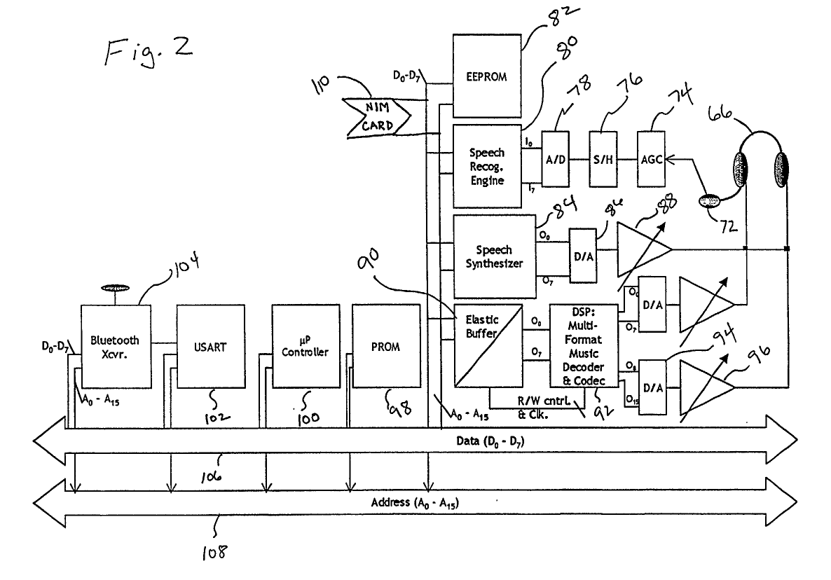

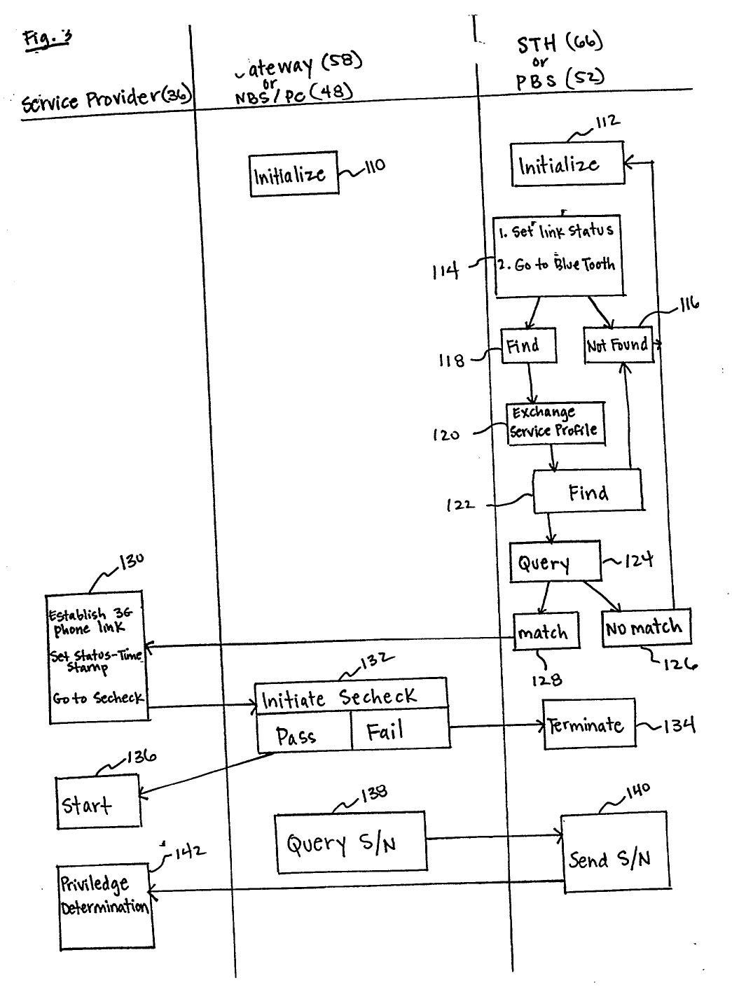

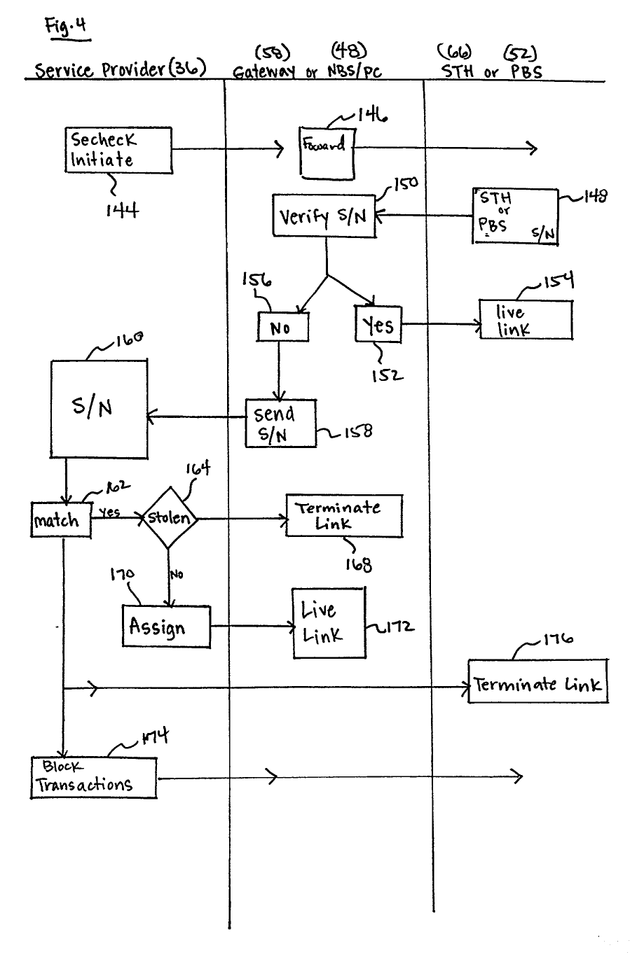

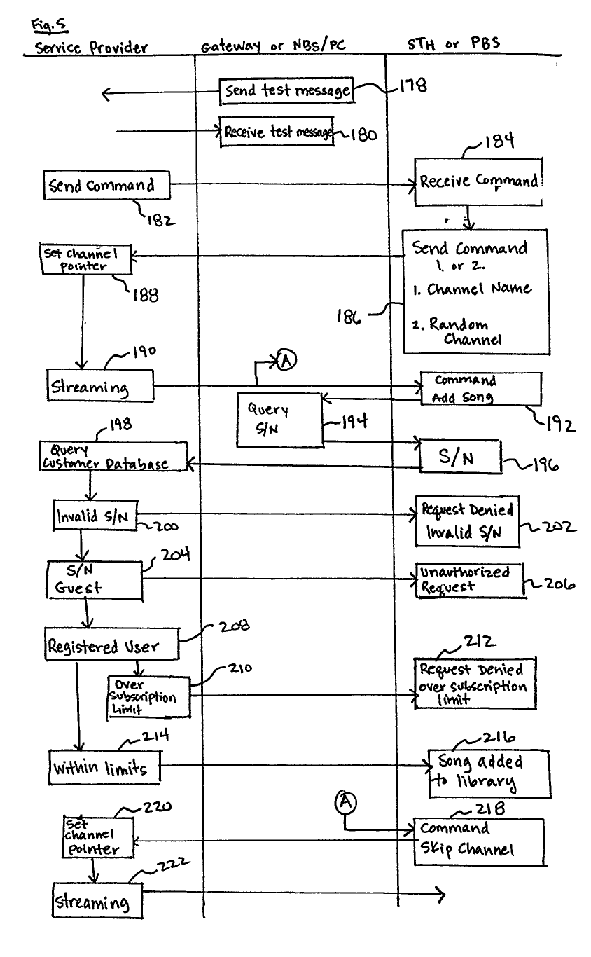

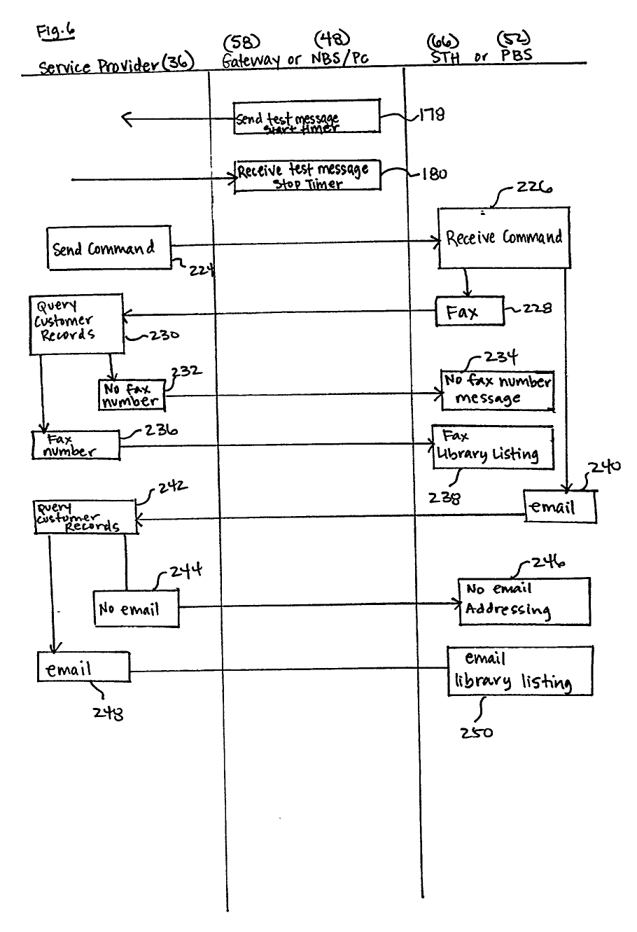

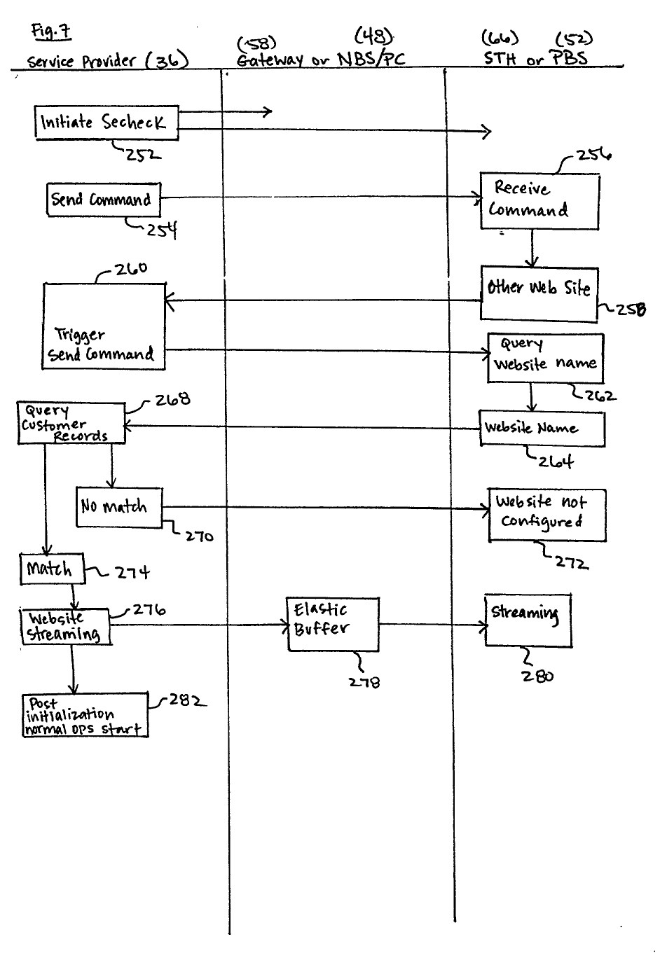

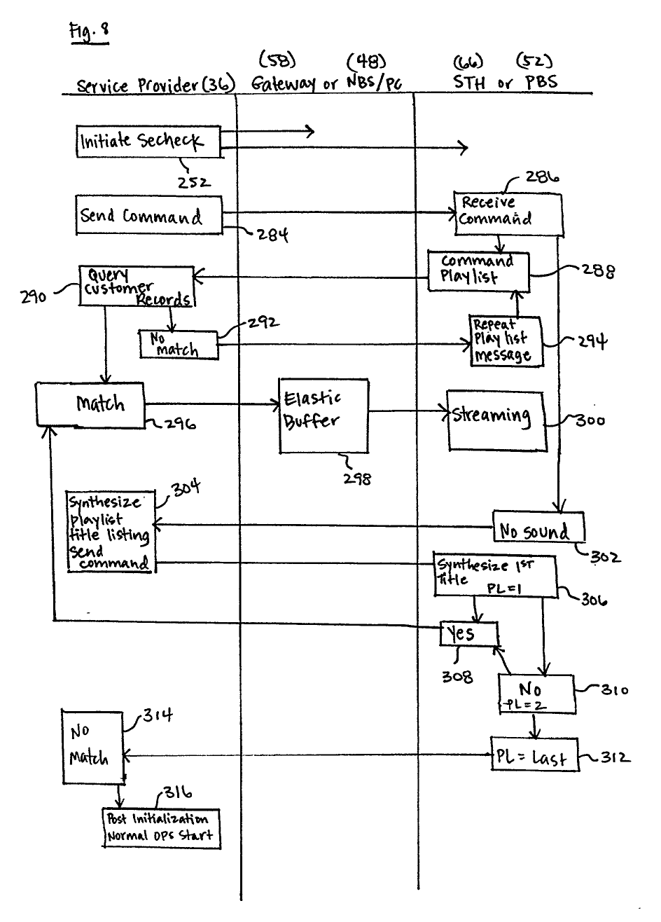

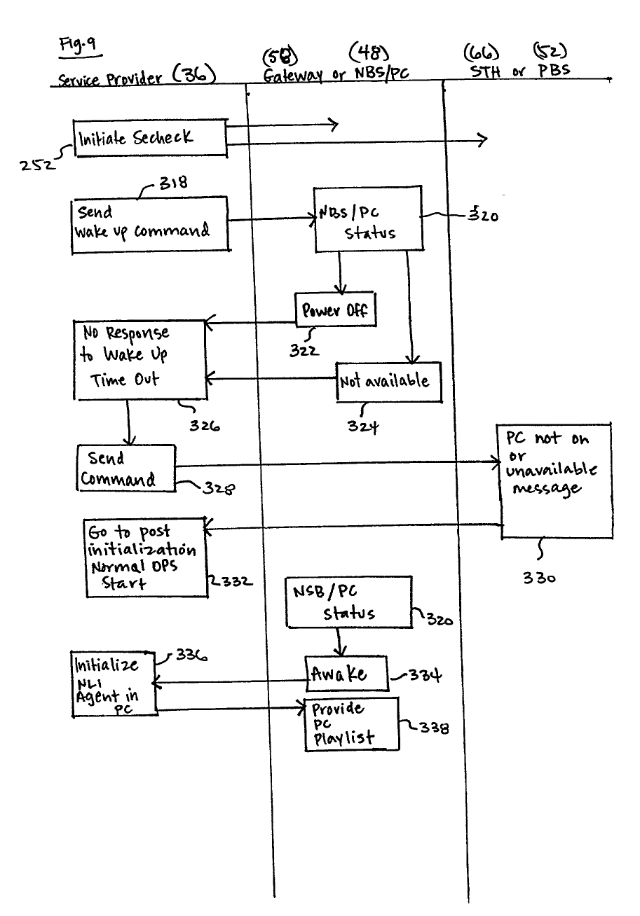

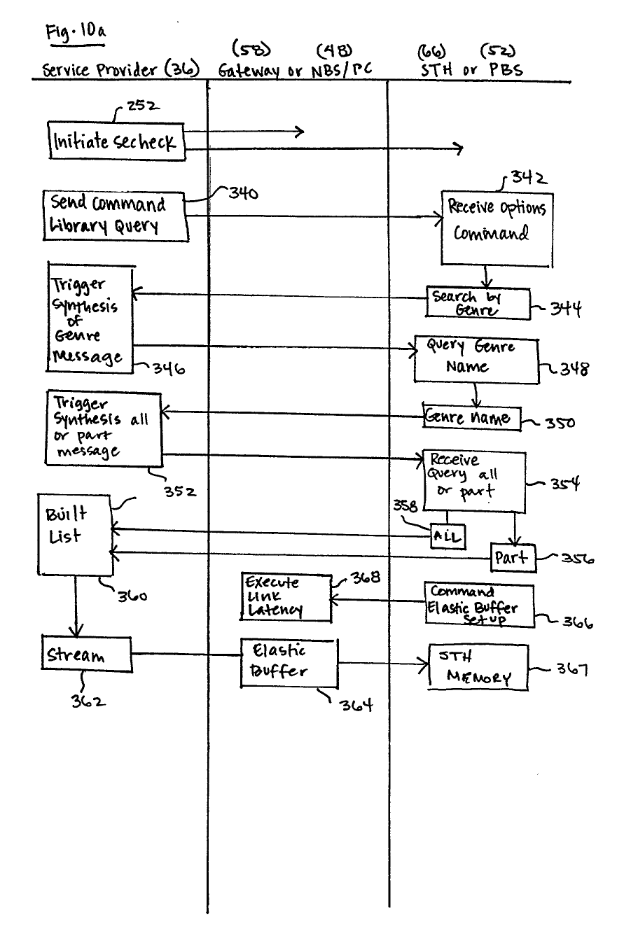

Referring now to the figures, wherein like reference numerals indicate like elements, in FIG. 1 there is shown a system for providing digital audio content to a user over the Internet 30. As will be described below, the system permits users to combine and utilize simultaneously the digital audio features of PCs, the internet, and their home audio equipment

The audio data files can be obtained from, or provided through, content providers 32, 34 on the Internet. These content providers can be such services as e-music.com and MP3.com. The service provider 36 communicates 38, 40 with each of the content providers 32, 34 in order to obtain such information as digital audio files and user libraries stored on content providers sites.

The block diagram of FIG. 1 represents a number of different methods provided in a preferred embodiment of the present invention for linking to and obtaining access to audio data through the service provider 36. In the first of these, a user plays back audio data files on their home stereo 42 through their PC 46 in full stereo and audio fidelity. To play back files, the user must connect to the service provider 36 over the internet 30 from their PC 46 using an Internet access device 44. Such devices include standard, DSL, and cable modems, ISDN lines, direct connections, and the like.

In order to connect to access files from the service provider 36 and play them on the user's home stereo 42, the user's PC 46 must have a network base station PC expansion card (NBS/PC) 48. The NBS/PC includes both firmware and circuitry, that preferably is provided on an ASIC chip 50, for linking to the service provider 36 and obtaining authorization therefrom to access the user's files. A playback station 52 is provided for receiving wireless communications 54 from the NBS/PC board 48. The playback station 52, which is connected to the home stereo 42 through an auxiliary input, contains a similar ASIC chip 56 to that of the NBS/PC board for linking the user's PC 46 to the user's home stereo 42.

In a second method, a gateway 58 can be directly provided with an ASIC chip to permit the gateway 58 to communicate 62 directly with the service provider 36 over the internet 30 and to the playback station 52 connected to the home stereo 42 without the use of a PC 46. The gateway 58 is used instead of the home PC in those situations where the user does not have a PC resident digital music library they wish to hear.

As also depicted in FIG. 1, a user having a 2.5 G or 3 G cell phone 64 can link to the service provider 36 over the Internet 30. As depicted in FIG. 1, an ASIC 65 is provided in the cell phone 64 to permit the cell phone to obtain authorization from the service provider 36 to access the user's files. A headset 66 is also provided with a similar ASIC 68 to permit the headset to communicate 70 with the ASIC 65 of the cell phone 64. It is envisioned that in the preferred embodiment of at least the cell phone, the functionality provided by the ASIC 65 will be provided by software stored in the existing memory of the phone.

The headset 66 combines wireless communications and digital audio processor control functions within a high quality stereo headphone set with a microphone. It implements remote command and control of the audio data file library management software running either at the service provider 36 of the user's PC 46 and provides untethered audio listening. In a preferred embodiment, the headset 66 contains speech recognition software which can be used to eliminate the need for a separate control keypad, keyboard, display or mouse. The headset can be used to enable commands to control and build the user's library with the service provider 36 or playlists stored on content provider servers 32, 34, or on their PC.

Although not shown, it should be understood that the headset 66 can communicate with the service provider 36 through the gateway 58 and PC 46 and the home stereo 42 can communicate with the service provider 36 through the cell phone 64.

The gateway 58 can also be used as a point of connection to a telephone line to provide call management functions. When in use, the system will answer an incoming call, an ask the caller to hold while the called party is located. The ASIC in the headset 66 will signal to pause the music and the user given an opportunity to answer the call by speaking into the microphone 72. If the answer is yes, the call is wirelessly connected to the headset 66. If the answer is no, the call is routed to the user's voice mail service. In the case of a call being connected to the headset 66, once the conversation is finished, the user can terminate the call through the headset microphone 72 and the music resumes.

In order to provide a connection for a telephone line in the gateway, the gateway can be provided as a Philips UCB-1300 or equivalent with an RJ-45 connection and an RJ-11 connection. The RJ-11 connection is for telephone management data functions such as answering incoming calls, placing calls on hold, notifying the user of the call, requesting the user to elect to take the call or send to the message service, and taking messages. The RJ-45 port is for data transfer associated with the audio files.

It is envisioned that a single ASIC package may provided for operation in each of the gateway 58, NBS/PC 48, playback station 52, headset 66, and cellular telephone 64. The ASIC contains the following circuitry the design of which is well understood: Bluetooth transceiver, voice recognition, voice synthesis, digital-to-analog and analog-to-digital conversion, amplifier, microphone and secure data storage.

The functioning of this circuitry described above will now be discussed in connection with FIG. 2 wherein the circuitry provided in a headset 66 is shown in block diagram form. It will be readily understood that while it is envisioned that most, if not all, of the circuitry shown will be included in the ASIC this is not necessary to the operation of the device.

As shown in FIG. 2, the headset 66 is provided with a set of speakers and a microphone 72. The circuitry associated with the microphone 72 includes adaptive gain control 74, sample and hold 76, and analg-to-digital conversion 78. The purpose and operation of this circuitry is well understood.

The circuitry associated with the microphone 72 also includes a speech recognition engine 80. The speech recognition engine includes circuitry and software for receiving and storing sample voice commands, for receiving input voice commands and comparing those to stored voice commands, and for outputting data corresponding to those voice commands to direct other circuitry and software to operate to achieve functions desired by the user. Examples of such functions will be described below in connection with FIGS. 3-10.

The electronically eraseable programmable read only memory (EEPROM) 82 is provided as the storage device for the speech recognition engine as well as other updateable data. Examples the data that may be stored in the EEPROM 82 include preprogrammed vocabulary for use in connection with the speech recognition engine, speaker dependent learned vocabulary, digitally recorded playlist names for music files, and indices for playlists and learned vocabulary.

The circuitry associated with the earphones of the headset 66 include circuitry associated with playing audio files and circuitry associated with outputting synthesized voice commands. Turning first to the synthesized voice output circuitry, a speech synthesizer 84 is provided for synthesizing voice from data files stored in the EEPROM 82. The synthesized voice messages can include messages regarding instructions for operation of the headset, messages identifying audio files in a play list, and messages that requesting an oral response to cause an operation to be performed.

It is envisioned that system will be provided with a telephone connection, either a land line connection or cellular connection. In this embodiment, it is envisioned that messages will be provided to the user through the headset that there is an incoming call and giving the user the option of accepting the call or not. If the call is accepted through an appropriate response, e.g., a spoken “yes,” the commands will be generated to shut off any audio file being played back and connecting the call through the headset. If a different response is received, e.g., a spoken “no,” the commands necessary to terminate the call or put the call into a answering service may be generated. It should be recognized that the foregoing are only examples and that spoken commands different from the above can be used to accomplish different objectives.

The speech synthesizer 84 provides output to a digital-to-analog converter 86, which in turn provides the signals to a volume controlled device 88 before being provided to the headset speakers.

Separately, in order to provide playback of audio files, an elastic buffer 90 is provided in the device for storing a portion or all of the audio file as transferred from the service provider server 36, FIG. 1, from a file in the user's PC 46, or from some other source. The storage capacity of the elastic buffer 90 should be selected to permit uninterrupted play of the audio file and thus will be dependent on limitations such as modem speed, file size, etc.

The elastic buffer 90 is connected to a digital signal processor (DSP) 92 which contains software for decoding different audio CODEC algorithms such as MP3, Liquid Audio version 5.0, Windows Media Audio version 7.0, linear pulse code modulation, etc. The DSP 92 is in turn connected to a digital-to-analog converter 94 to convert the digital output from the DSP into an analog form for broadcast through the headset 66 speakers. A volume controlled 96 is provided for adjusting the volume of the broadcast over the speakers.

A programmable read only memory (PROM) 98 is provided for storing microcontroller firmware used for operating the headset 66. In addition, the PROM 98 stores the DSP 92 music decoder firmware needed to decode the various audio data encoding formats. The PROM 98 will also store any standard command messages and words to be provided to the user. A serial number identifying the device may also be provided in the PROM 98 to be used in authenticating the device to the service provider server 36 to prevent fraud. In order to ensure fraud prevention, the circuitry may also be provided with an encryption engine to encrypt the serial number during transmission and circuitry which erases or otherwise renders the serial number unrecoverable in the event of tampering with the device.

The microcontroller 100 is provided as the computational engine for the circuitry and is connected to and controls the other circuitry through communications over a data bus 106 and address bus 108. To provide wireless communication capability, the device is provided with a universal synchronous-asynchronous receiver-transmitter (USART) 102 connected to a Bluetooth transceiver 104.

The Bluetooth transceiver 104 permits the device in which it is installed to transmit over a limited range of ten centimeters to one hundred meters using the Bluetooth specification. By using this communication protocol, a headset 66 can be used in conjunction with a cellular phone worn on a waist belt without the concern of interference from or to surrounding transmitters or receivers. In another example of the flexibility provided by use of the Bluetooth communication protocol, a headset 66 and one or more home stereos 42 can be located at different places within a home and all communicate with a central PC 46 or gateway 58. It can be readily understood that various arrangements of devices falling within the scope of the present invention can be provided using this technology, e.g., self-guided museum tours, and thus the foregoing description is not intended to be limiting.

Also depicted in FIG. 2 is an information module 110 which is an insertable card used to store user information used in authorizing access to the service provider server 36. By storing user identification data on the information module, a user can access the service provider server 36 from any device having a module port.

While the foregoing discussion of the circuitry has been in connection with the headset device, similar or identical functions will be performed by the playback station 52 and its ASIC 56, NBS/PC 48 and its ASIC 50, gateway 58 and its ASIC 60, and cellular phone 64 and its ASIC 65 or software. Thus, it will be readily understood from the foregoing discussion how the circuitry would be provided for these other devices.

Prior to the first use of the system of FIG. 1, the user will need to register with the service provider. The process of doing this will vary dependent on the mode of communication with the service provider. For example, where the user has a PC 46 and no preexisting libraries of audio files, the user would go through the following procedure in order to register: (1) the user installs the NBS/PC card into the PC and a CD ROM into the CD ROM drive containing an install wizard for the software needed to register; (2) the software wizard asks the user if they have any music stored on any content provider server, (3) the user would respond in the negative and the software wizard would then create a directory path for future use, (4) the software wizard asks the user to turn on the headset 66 or playback station 52, (5) the software wizard and NBS/PC establish a Bluetooth link and the software wizard obtains the device serial number from the headset 66 or playback station 52, (6) the NBS/PC then establishes a link with the service provider server 36 to provide user identification information that will be input by the user, the user identification information includes credit card number and expiration date, wireline telephone number, e-mail address, fax number, and cellular phone number, (7) if the cellular telephone number is provided it will then be sent to the stereo head set 66 so that the user can use the head set 66 in connection with the cellular phone, (8) the user will then elect user privileges such as subscription level, e.g., number of audio files that may be downloaded or played per month, and will identify any other online audio library sources used by that user, e.g., MediaBay.com, MP3.com, etc., (9) the serial numbers for the stereo headset, NBS/PC and playback station are then transmitted to the service provider.

Where the user has a PC 46 and preexisting audio file libraries on the PC, the user would answer in the affirmative during step 3 above and the software wizard will perform the following steps: (1) have the user browse to and identify the files currently being used for audio storage and music jukebox programs, (2) build a database of audio files by searching the hard disc of the PC 46 for files of appropriate extension IDs, and (3) searches juke box programs files for play list titles and song lists.

Where the user has both audio file libraries on the PC 46 and at Web sites on the Internet, the software wizard will also ask the user for web site urls, preferably by use of a pull down menu of audio web sites, and the user's password and ID for each url where the user has a virtual library or locker site.

Where the user does not have a PC 46 but will instead be using a gateway 58, the following steps will be performed: (1) the user will be directed by written instruction to insert batteries into the stereo headset 66 or turn on the power of the play back station 52, (2) the gateway 58 establishes a Bluetooth link to the stereo headset or playback station 52 and gets the serial numbers from the stereo headset 66 or playback station 52, (3) the gateway links to the service provider server and invokes a software wizard to create a record in the New Customer Database that includes the stereo headset 66 or playback station 52 serial numbers, (4) the written instructions then prompt the user to contact the service provider telephone number in order to register the user.

The method of operation of the system of FIG. 1 will now be described in connection with the flowcharts of FIGS. 3-10. Referring first to FIG. 3, after first performing the registration process described above once, when the user wishes to use the system the PC 46 or gateway 52 must be initialized 110, 112. During initialization, the gateway 52 or NBS/PC 48 powers on and performs a self test. If the self test is successful, identifying information and Bluetooth service profile information is sent to the head set 66 or playback station 52. A bluetooth handshake with the stereo headset 66 or playback station 52 is also performed.

Similarly, in the stereo head set 66 or playback station 52, power is turned on and a self test is performed. If the self test is successful, identifying information and Bluetooth service profile information are transmitted by the headset 66 which will be responded to by the gateway 58, NBS/PC 48, and/or cell phone 64, FIG. 1. In this way, the headset will know whether it is in range of a gateway, NBS/PC, or cell phone providing service. A Bluetooth handshake with the gateway 58, NBS/PC 58, or cell phone 64 is then performed 114.

For the discussion which follows only the gateway 58 and headset 66 will be described. It should be understood that the NBS/PC 48 can be substituted in this discussion for the gateway 58 and the playback station 52 for the headset 66.

If a gateway 58 is available, the headset 66 will first attempt the Bluetooth handshake with that gateway 58. If this handshake is unsuccessful 116 and the connection of the headset 66 to the gateway 58 cannot be established, the headset 66 will then restart the initialization step 112 and look to make the connection with another device. If the handshake is successful 118, the headset 66 and gateway 58 exchange Bluetooth service profiles 120.

If the gateway 58 connection cannot be established, the headset 66 will look for a cell phone connection 122, assuming that the user has set their privileges to allow a cell phone connection, and if one is not found 116 the headset returns to the initialization step 112. If the cellular phone connection is found a query is then performed for the phone number to see if it matches the phone number stored in the headset 66. If it does not match the headset 66 returns to the initialization step 112. If there is a match 128, a link 130 is created with the cellular phone 64.

The link status in the customer database at the service provider server 36 is set to the “on the go” status indicating that the user is connecting through a cell phone. A time and date stamp is also set at this stage before a serial number check procedure 132 is performed. If the serial number check procedure 132 is negative the system set up is terminated 134. Alternatively, if the serial number check procedure 132 is positive the system start up is permitted 136. Once system start up is permitted 136, the gateway 58 provides 138 its serial number to the headset 66 and the headset provides 140 its serial number to the service provider 36. Upon receipt of the serial numbers the service provider 36 determines the users access privileges 142.

In FIG. 4 there is shown, in flow chart form, the serial number check procedure 132 used to confirm authorization of the gateway 58 and stereo headset 66. In a presently preferred embodiment, the serial number check procedure 132 is initiated by a watch dog timer every 5 minutes in the background during playback.

The serial number check procedure 132 is initiated by the transmission of a serial number check (“SECHECK”) message 144 by the service provider 36 to the gateway 58. The SECHECK message is then forwarded by the gateway 58 to the stereo headset 66.

In response to the received SECHECK message, the stereo headset 66 transmits its serial number 148 to the gateway 58. The gateway 58 verifies that the serial number transmitted 148 from the stereo headset 66 is the same serial number transmitted by the headset 66 during the initialization procedure 140, FIG. 3. If the serial number received by the gateway 58 from the stereo headset 66 matches the serial number transmitted from the stereo headset during initialization 152 the link between the service provider 36, gateway 58 and stereo headset 66 is maintained 154.

If the serial number received by the gateway 58 from the headset 66 does not match with the serial number transmitted by the headset 66 during initiation 156, the serial number transmitted 148 by the current headset 66 is forwarded 158 to the service provider 36. At the service provider 36, the serial number 160 is compared to the list of approved devices stored in memory at the service provider 162. If the serial number matches, a second inquiry will be undertaken to determine if the device has been reported stolen 164. If the device has not been reported stolen, and is an approved device, a message is transmitted from the service provider 36 to the gateway 58 to maintain the link 172.

If the serial number received by the service provider 36 for the headset 66 does not match with one of the serial numbers of approved devices as stored in memory at the service provider 36, any further transfers of data to the gateway 58 will be disallowed 174. The link to the stereo headset 66 will also be terminated 176.

The procedure for listening to an audio file will now be explained with reference to the flow chart of FIG. 5. This process relates to a default play process where audio files are played independently of any user play lists such as on the radio. In order to set the elastic buffer in the gateway 58 a test message 178 is sent from the gateway 58 to the service provider 36 and a timer in the gateway 58 is started. The service provider 36 receives the test message and sends it back to the gateway 58. When the gateway 58 receives the test message back 180 it stops the timer and then calculates the latency of the channel. Based upon this calculation, the elastic buffer in the gateway 58 is set at a sufficient size to permit uninterrupted playback of an audio file.

The service provider 36 sends a command message 182 to the headset 66 requesting playback instructions. The command message is transmitted through the gateway 58 and received 184 at the headset 66. In response to the command message, the user is prompted by an appropriate message to select a channel or initiate random play 186. The user responds to this request by speaking an appropriate instruction into the headset 66. An appropriate instruction can be the selected channel name or number or a directive “random play.” It should be understood that in the case of the playback station 52, instructions can be provided orally by a microphone or can be entered through a touch screen or other suitable input/output device.

The user's response is transmitted back through the gateway 58 to the service provider 36 where a pointer is set to either the selected channel or a random channel 188. The service provider 36 then begins streaming the selected audio file 190 to the headset 66 through the gateway 58.

During streaming of the audio file 190, the user can request to add the song to their library 192 by speaking this command into the headset 66. If this request is made, the gateway 58 will first query the serial number 194 of the headset 66 to identify the user. The headset 66 will then forward its serial number 196 to the service provider 36 which will then search its customer database for the user 198.

If the service provider 36 will then determine whether the serial number is valid 200 and, if not, the request will be denied 202 and the link terminated. If the serial number is a valid serial number but that of a guest 204, i.e., it is not the serial number of the user whose account is being used, the request will be denied and the user will be informed that they cannot request this operation 206.

If the serial number is valid and that of the user whose account is being used 208, the operation will be permitted to move forward. Because it is envisioned that different levels of service will be provided at different costs, e.g., basic service allowing 15 audio files per months to be added to a user's library, advanced service allowing unlimited audio files to be added to the user's library, the service provider 36 will determine if the user has reached their limit of subscriptions. If the limit has been reached 210, the user will be informed that they have reached their limit and that their request is denied 212. Conversely, if the limit has not been reached 214, the audio file will be added to the user's library 216.

During streaming 190, the user can also request that an audio file be skipped 218. If this request is made by the user, the audio file currently being streamed will stop and the pointer will be set to the next audio file 220 and the next audio file will begin streaming 222 from the service provider 36 to the headset 66.

The process for forwarding a user's library listing to them by facsimile or e-mail will now be explained with reference to FIG. 6. As with the playback process of FIG. 5, the test message will be sent 178 by the gateway 58 to the service provider 36 and returned 180 to the gateway 58 in order to set the elastic buffer. Once the elastic buffer has been sent, the service provider 36 will send a command 224 to the headset 66 to trigger execution of a library listing function.

In response to this message, a standard message in memory of the headset 66 will be played back to the user asking the user to select whether they want the library listing sent by facsimile or by e-mail. If the user selects facsimile 228 by an appropriate oral response, the service provider 36 will query the user records for the user's facsimile number 230. If the user has not provided a facsimile number 232, a command is sent to the headset directing a standard message to be played stating that the service provider does not have a facsimile number for the user 234. If the service provider has a facsimile number for the user 236, the service provider 36 will send a copy of the user's library listing to the user by facsimile.

Conversely, if the user had selected the e-mail option 240, the service provider 36 would again query its customer records for the user's e-mail address 242. If no e-mail address is found for the user 244 a command will be sent to the headset 66 directing that a standard message be played back informing the user that no e-mail address exists in the service provider's records 246. If an e-mail address has been provided to the service provider 248, the library listing will be forwarded by e-mail to the user 250.

The process for playing an audio file from a user's play list stored on a web site other than that of the service provider 36 will now be explained with reference to FIG. 7. As depicted in FIG. 7, before this process begins the service provider 36 initiates a serial number check 252 by both the gateway 58 and the headset 66. It should be understood that the service provider may choose only to check the serial number of the headset 66 in order to determine the identity of the user.

To begin playing an audio file from a user's play list stored on another web site, the service provider 36 sends a command 254 to direct the headset 66 to play a standard play list location message to the user. The standard message will ask the user whether the play list is stored with the service provider 36, on another web site, or on the user's PC. The discussion that follows will describe the process performed where the play list is on another web site. The process utilized when the play list is stored on the service provider's web site, and on the user's PC, will be described below with reference to FIGS. 8 and 9, respectively.

When the user responds to the service provider 36 that the play list is on another web site 258, the service provider generates another command message 260 to the headset 66 to query the user for the web site name 262. The user then provides the web site name 264 to the service provider 36 by speaking into the microphone 72 of the headset 66.

When the service provider 36 receives the web site name it queries its database of customer records 268 to see if the provided web site matches with any stored in the database for the user. If there is no match 270, a command is sent to the headset 66 directing it to play a message 272 indicating that the selected web site is not on the configuration list of the service provider for that user.

If there is a match in the service provider database for the selected web site 274, the service provider goes to the web site's url and provides the user's ID, password, and play list ID. The audio files on the identified web site are then transferred to the service provider server and streamed 276 to the elastic buffer 278 of the gateway 58 and then streamed 280 to the headset 66. Following the transfer of the audio file from the web site to the service provider server, the service provider operates in the normal operation mode discussed in connection with FIG. 5.

When, in response to the message requesting the location of the play list 256, the user responds with a play list stored with the service provider, the service provider 36 sends a command 284 to the headset 66 directing a message to be played asking the user to identify the play list 286. It is envisioned that the user will also be given the option of having all play lists played back so that a selection can be made by responding affirmatively after a title is read.

If a play list is identified 288 is identified by the user, the service provider will search its records for the user 290 to determine if the identified play list exists. If no match is found 292, the message requesting the user to identify a play list will be repeated 294, preferably with a message that the response could not be understood and that the user should try again. This same message may be repeated a number of times before this loop is terminated and normal operation may begin as discussed in connection with FIG. 5. If, alternatively, a match is found for the play list 296 the elastic buffer of the gateway 58 will be set 298 and streaming of the play list will begin 300.

Where the user does not respond within a predetermined period of time 302 to the request to identify a play list 286, the headset 66 will then send a command message to the service provider 36 initiating the synthesis of a play list title listing message 304. The headset 66 then synthesizes and begins playing the user's play lists 306. If the user's selects the first play list read 308, this will be a match 296 with one of the user play lists stored in the service provider server (because it has been synthesized out of the service provider memory), the elastic buffer will be set 298 and the play list streamed 300 to the user headset 66.

If the play list read to the user 306 is not selected by the user, the next play list will be read 310. If selected, the second play list will be streamed 300 to the user headset 66 as described above. This loop will continue through all of the user play lists until one is selected 308 or the final play list is reached 312. If the final play list is read but not selected, a message is sent to the service provider that there was no match 314 play defaults back to normal operations 316 as described in connection with FIG. 5.

If the user identifies a play list on their PC, a serial number check is first performed 252 and then a message 318, FIG. 9, is sent by the service provider 36 to the NBS/PC board 48 in the PC to ascertain the status of the board 320. IF the NBS/PC board is off 322 or otherwise not available 324, this will be reported 326 to the service provider 36. A command 328 will then be sent to the headset 66 directing that a message be played 330 notifying the user that the PC is not on or not available. Normal play will then commence as discussed in connection with FIG. 5.

If the status of the NBS/PC board 48 is that it is available 334, the service provider 36 will direct the NBS/PC 48 in the PC to initialize 336. The NBS/PC 48 in the PC will then transfer the play list 338 to the headset 66 by taking over the Bluetooth connection to the headset and streaming the play list to the headset 66.

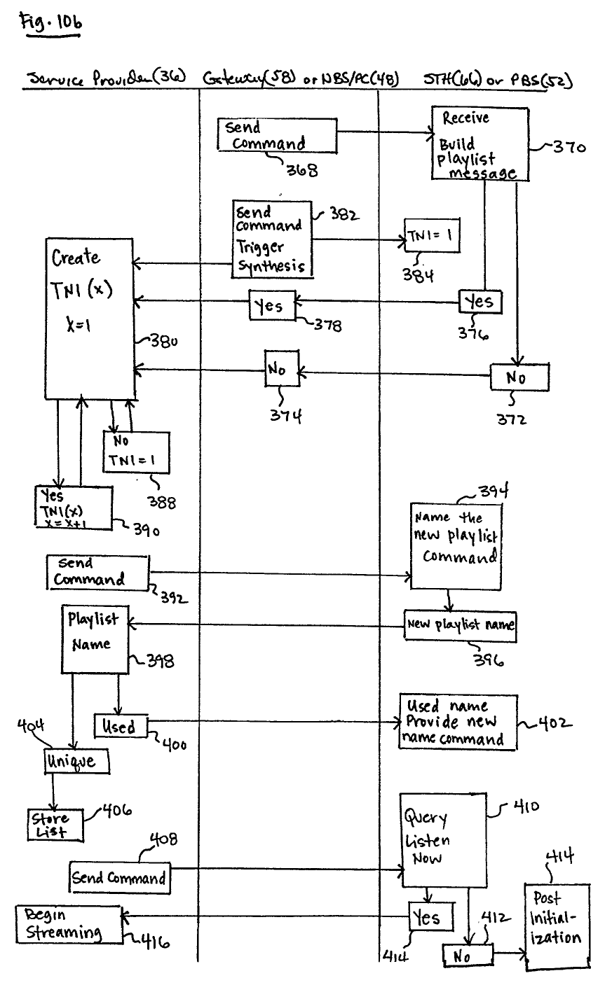

The process of creating a play list will now be described in connection with FIGS. 10A and 10B. Following the serial number check procedure 252, a command will be sent from the service provider 36 triggering a library query message 340 at the headset 66. In response, the headset 66 will provide a message to the user to select whether to search by artist or genre 342. If the user elects to search by genre 344 by saying “genre” into the microphone 72, the service provider 36 will then issue a command to identify the genre 346. In response to this command 346, the headset 66 will play a message to the user asking them to state the genre name 348. The user then states the genre name 350. Identification of the genre name prompts the service provider 36 to send out a command to ask the user whether they wish to have all or merely a portion of their library included in a play list 352.

A query message 354 is then provided to the user through the headset 66 asking whether all or part of the audio files of the selected genre in a user's library should be included in a play list. If all of the audio files in the library are to be included on the play list, the service provider 36 will build the play list. Simultaneous to the response to the service provider 36 whether to provide all or part of the library on the play list, a command 366 is sent by the headset 66 to the gateway to execute the link latency measurement in order to set up the elastic buffer 368. The play list will then be streamed 362 from the service provider 36 to the gateway 58 elastic buffer and then to the headset buffer 367.

If only a portion of the audio files in the library are to be included on the play list the service provider will transfer the names of the audio files of the selected genre and the number of tracks of the genre in the library to the elastic buffer of the gateway 58. A command 368 is then sent by the gateway 58 to the headset 66 to build a play list. A message 370 is provided through the headset 66 to the user identifying, one at a time, the titles in the library and requesting that the user state “yes” or “no” whether to include the audio file on the play list. When an audio file is identified to the user and they respond negatively regarding inclusion on the play list 372, this is provided to the gateway 58 and forwarded on 374 to the service provider 36. Similarly, if the user responds affirmatively 376, this is forwarded on 378 to the service provider 36 so that the audio file is included on the play list.

The process for creating the play list includes the service provider 36 assigning a number “N” to each audio file in the library for the selected genre. A track number index array (TNI(X)) 380, is also created for storing all of the selected tracks for inclusion on the play list. The number of possible entries in the array is equal to the total number of audio files in the library for the selected genre but it is assumed that it will be less than the total.

To create the play list, a title of an audio file is provided to the user through the headset 66 and a message is played requesting the user to decide whether they wish the audio file to be added on the play list. If the response from the user is negative the track number will be increased by one in order to query the user about the next track but the number in the index array will remain the same since the audio file in not placed on the play 388. Alternatively, if the user responded affirmatively, the audio file will be assigned to the current number in the track number index array, track number will be increased by one to query about the next audio file and the track number index array will be increased by one 390.

By way of example, if a library of jazz music contains one hundred audio files the first will be identified to the user. If the user decides to add this first file to the play list it would be assigned TNI(1) in the array. Similarly, if the user decides to add the second file to the play list this would be assigned TNI(2) in the array. If the third file is not added to the play list, TNI(3) would not be assigned to this title but would instead be reserved for the next title to be added to the play list, e.g., file number seven assigned to TNI(3), etc.

Once the play list is created a command 392 is sent by the service provider 36 to the headset 66 to request the user to name the play list. A message will be played to the user asking the user to record a name for the play list 394. The user then digitally records a play list name 396, which trains the speech recognition engine to recognize the name. The data for the recorded play list name is then sent to the service provider where the service provider will query its database to ensure that the data representing the play list name is unique 398. If the data is not unique 400, typically because the same user has already used the name, the user will be asked, through the headset 66, to provide a new name 402. If the name is unique 404, the name will be stored by the service provider 406.

Once the list is stored with a name, the service provider will initiate a query 408 to the user to ask whether the user wishes to listen to the play list 410. If the user responds negatively 412, the normal play procedure will begin as described in connection with FIG. 5. If the user responds positively 414, the service provider will begin streaming the audio files in the play list 416.

The above description and drawings are only illustrative of preferred embodiments which achieve the objects, features, and advantages of the present invention, and it is not intended that the present invention be limited thereto. Any modification of the present invention which comes within the spirit and scope of the following claims is considered to be part of the present invention.

What is claimed is:

1. System for transmitting audio data files, comprising:
a service provider server for storing a plurality of audio data files and categorization data for said audio data files;
a data transmitting device including circuitry for accessing said service provider server to obtain an audio data file and said categorization data, and circuitry for wirelessly transmitting said audio data and categorization data; and
a data receiving and playback device including circuitry for wirelessly receiving said audio data file and said categorization data from said data transmitting device, and circuitry for outputting said categorization data and decoding said audio data file to be broadcast in full stereo and audio fidelity.

2. The system of claim 1 wherein said audio data files are compressed music files.

3. The system of claim 2 wherein said categorization data is a library of music files available to a user.

4. The system of claim 1 wherein said data transmitting device is a cellular telephone.

5. The system of claim 1 wherein said data transmitting device is a personal computer and wherein said circuitry included in said computer is provided on an extension board.

6. The system of claim 1 wherein said data receiving device is a playback station and wherein said speaker is included in a stereo, said playback station connecting to said stereo through an auxiliary input for said stereo.

7. The system of claim 1 wherein said data receiving device is a wireless stereo headset.

8. The system of claim 7 wherein said stereo headset further includes a microphone for inputting voice commands and wherein said voice commands are converted into commands to direct said service provider server to transfer an audio data file to said transmitting device.

9. The system of claim 8 wherein said data transmitting device is a cellular telephone.

10. The system of claim 1 further comprising a removeable information module which, when provided with said data receiving and playback device, authorizes said data receiving and playback device to receive said audio data file.

11. The method of claim 10 wherein said removeable information module can be provided for use, at separate times, with a plurality of data receiving and playback devices.

12. Method of transmitting and playing audio data files, comprising the steps of:
accessing categorization data for a plurality of audio data files from a service provider server;
outputting said categorization data through an output device;
selecting an audio data file to be played on a speaker using said categorization data;
transferring said audio data file from said service provider server to a data transmitting device;
wirelessly transmitting said audio data file to a data receiving and playback device;
broadcasting said audio data file through a speaker.

13. The method of claim 12 wherein said audio data files are compressed music files.

14. The method of claim 13 wherein said categorization data is a library of music files available to a user.

15. The method of claim 12 wherein said data transmitting device is a cellular telephone.

16. The method of claim 12 wherein said data transmitting device is a personal computer and wherein said computer includes circuitry included in said computer is provided on an extension board.

17. The method of claim 12 wherein said data receiving device is a playback station and wherein said speaker is included in a stereo, said playback station connecting to said stereo through an auxiliary input for said stereo.

18. The method of claim 12 wherein said data receiving device is a wireless stereo headset.

19. The method of claim 18 wherein said headset includes a microphone and wherein said method further includes the steps of:
inputting voice commands to said headset; and
converting said voice commands into commands to direct said service provider server to transfer an audio data file to said transmitting device.

20. The method of claim 19 wherein said data transmitting device is a cellular telephone.

21. The method of claim 12 wherein said output device comprises a television screen and cable television box.

22. The method of claim 12 wherein said output device is the display of a cellular phone.
